(19) United States
(12) Patent Application Publication
(10) Pub. No.: US 2011/0174130 A1
(43) Pub. Date: Jul. 21, 2011

(54) CUTTING TOOL

(75) Inventor: Charlie Zhang, Oak Brook, IL (US)

(73) Assignee: D-Cut Products, Inc., Downers Grove, IL (US)

(21) Appl. No.: 12/987,585

(22) Filed: Jan. 10, 2011

Related U.S. Application Data
(60) Provisional application No. 61/295,250, filed on Jan. 15, 2010.

(51) Int. Cl. B26D 5/16

(52) U.S. Cl. 83/602

(57) ABSTRACT

A portable, non-power operated cutting tool for cutting sheets of building materials in a straight fashion without splintering or cracking. The cutting tool includes a base, a blade holder with a blade, and a handle with an eccentric cam rotatably connected to the base, where the blade holder moves between an open position and a closed position by rotating the eccentric cam.

### CROSS REFERENCE TO RELATED APPLICATION

This application claims the benefit of U.S. provisional patent application Ser. No. 61/295,250, filed on 15 Jan. 2010. This co-pending provisional patent application is hereby incorporated by reference herein in its entirety and is made a part hereof, including but not limited to those portions which specifically appear hereinafter.

### BACKGROUND OF THE INVENTION

1. Field of the Invention

This invention relates to a cutting tool for cutting sheets of material, such as, for example, sheets of building materials. More specifically, this invention relates to a cutting tool including a base, a blade holder with a blade pivotally connected to the base, and a handle with an eccentric cam rotatably connected to the base, where the blade holder moves between an open position and a closed position by rotating the eccentric cam.

2. Discussion of Related Art

Certain building materials, such as, for example, flooring materials and siding, are provided as sheets or planks of various dimensions. When used on a job site, the sheets or planks must be customized to meet the specific requirements of the job site. For example, the sheets or planks must be cut to fit around edges or corners of a room and/or around fixtures. Various tools are currently used to cut sheets of building materials, but most are bulky, heavy, require power to be operated, produce large amounts of dust during the cutting process, and/or result in uneven or splintered cuts.

There is a need or a desire for an improved cutting tool for cutting sheets or planks of building materials. There is a need or a desire for a portable, non-power operated cutting tool able to cut sheets of building materials in a predictable and straight fashion without splintering, cracking or similar problems and providing fast, dust-free cutting.

### SUMMARY OF THE INVENTION

The present invention provides a portable, non-power operated cutting tool for cutting sheets of building materials in a straight fashion without splintering or cracking.

According to one embodiment of this invention, the cutting tool includes a base with a support surface, a blade holder with a blade, and an eccentric cam with a handle.

The blade holder includes a fixed end that is hingely connected to the base at a blade holder pivot point and a free end opposite the fixed end. The eccentric cam is positioned over the free end of the blade holder and is rotatably connected to the base at a cam pivot point. In a preferred embodiment, the blade holder pivot point is spaced from the cam pivot point at a distance sufficient to allow the material to be cut to fit between.

In operation, the blade holder is movable from an open position to a closed position by rotating the eccentric cam. In the open position, the blade holder is in contact with the eccentric cam at a relatively small radius of the cam. In this position, a material to be cut can be placed in an opening provided between the blade and a portion of the base, preferably a blade stop. To cut the material, the handle is lowered to rotate the eccentric cam. As the cam rotates, a gradually increasing radius of the cam comes in contact with the blade holder forcing the blade holder downwards until the blade contacts the base, thereby severing the material. A resulting cut is optimally free of splinters and the resulting cut end of the material is otherwise clean and straight.

### BRIEF DESCRIPTION OF THE DRAWINGS

FIG. 1 is a perspective view of a cutting tool according to one embodiment of this invention;

FIG. 2 is another perspective view of the cutting tool shown in FIG. 1 with a sheet of material to be cut;

FIG. 3 is a side view of the cutting tool shown in FIG. 1 in an open position;

FIG. 4 is a side view of the cutting tool shown in FIG. 1 in a closed position; and

FIG. 5 is an opposite side view of the cutting tool shown in FIG. 1 in the closed position; and

FIG. 6 is an end view of the cutting tool shown in FIG. 1.

### DESCRIPTION OF THE INVENTION

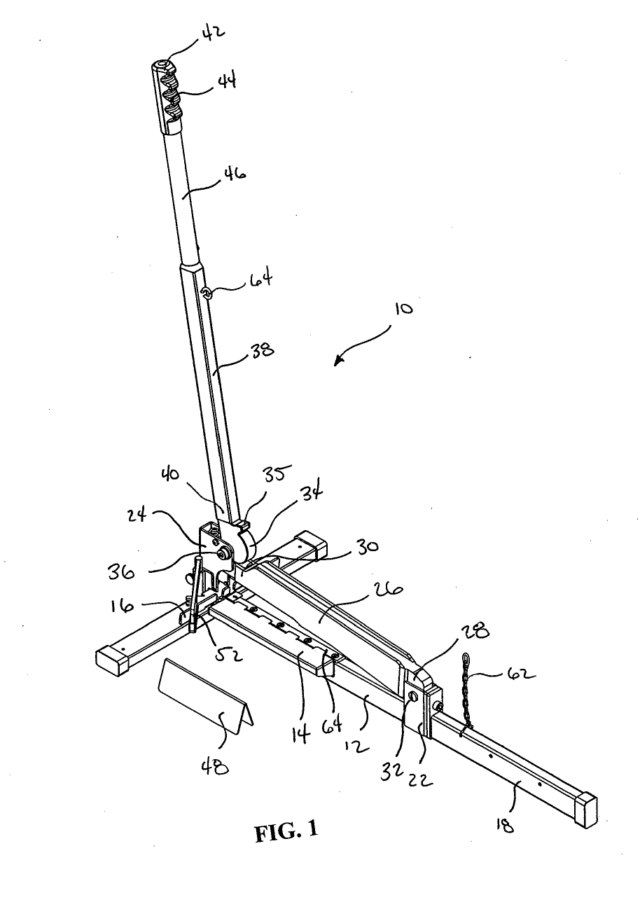

FIGS. 1-6 show a cutting tool 10 according to one embodiment of this invention. The cutting tool 10 as described is preferably used to cut building materials 50, such as flooring, in a predictable and straight fashion without splintering, cracking or similar problems that may arise from such cuts.

As used herein, “material” refers to a sheet or plank of building material, preferably flooring, such as wood flooring, laminate flooring, parquet flooring, composite flooring, wood trim, baseboards, vinyl flooring, vinyl siding, vinyl composition tile or similar materials, including, but not limited to, one or more combinations of wood, fiber, concrete, plastic and/or other materials that may or may not include a laminated layer.

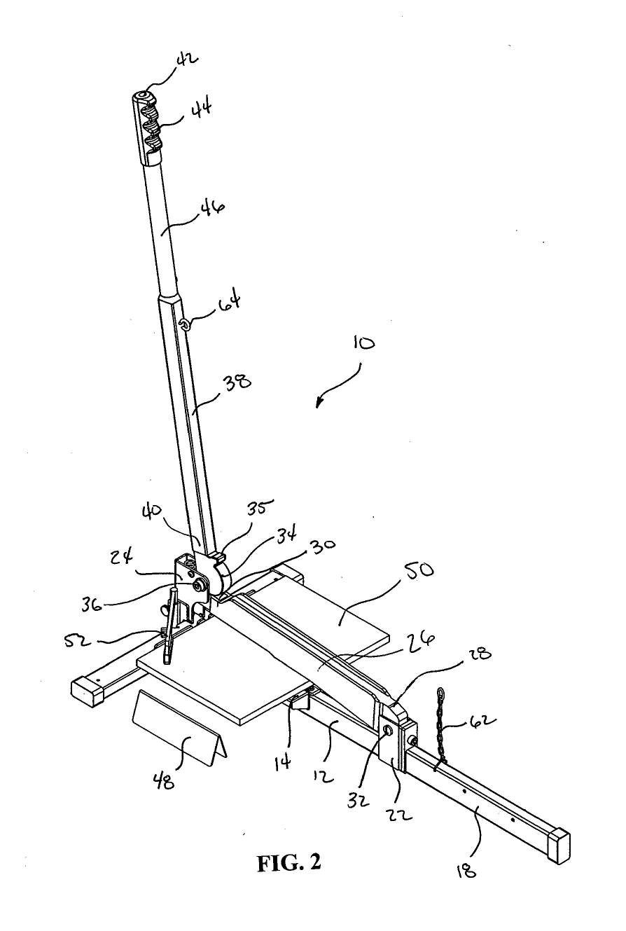

The cutting tool 10 includes a base 12 that may be formed of steel or other similar rigid material. As shown in FIG. 1, the base 12 is T-shaped, however, the base 12 is not limited to a T-shape and can be any shape capable of providing support to the cutting tool 10. The cutting tool 10 preferably includes a support surface 14 attached to the base 12. The support surface 14 is desirably sized to accommodate a type of material to be cut, including for example, but not limited to, an 8 inch plank of flooring. As shown in FIGS. 1 and 2, additional support for the material 50 to be cut can be provided by a support element 48.

In a preferred embodiment, the cutting tool 10 includes at least one guide rail 16 to orientate the material 50 with respect to a blade 20. The guide rail 16 can be set up to provide a rest for the material 50 to be cut at a right angle. In a preferred embodiment, the guide rail 16 includes a plurality of coupling forks which allow the guide rail 16 to be attached to the cutting tool 10 at a plurality of angles to the blade 20. For example, the plurality of coupling forks allow the guide rail 16 to be attached to the cutting tool 10 at angles of 45°, 90° and 135° to the blade 20. In a alternative embodiment, the guide rail 16 includes a means to rotate about an axis perpendicular to the support surface 14 and a mechanism to lock the guide rail at an angle to the blade 20, allowing materials to be cut at any angle from 0° to 180°.

The base 12 further includes a base extension 18 for increased stability of the cutting tool 10. In an embodiment of this invention, the base extension 18 is extendable and can operate in multiple ways including, but not limited to, a telescopic extension, a pivoting extension, or a bolt-on extension.

In an embodiment of this invention, the cutting tool 10 includes a means for lining up the material 50 to be cut with the blade 20, for example, the cutting tool 10 can include a laser guide for lining up the material to be cut.

Connected to the base 12 is a pair of risers, a blade holder riser 22 and a cam riser 24. In this embodiment, the blade holder riser 22 and the cam riser 24 are bolted to the base 12. However, the blade holder riser 22 and the cam riser 24 can be secured to the base by any means including a weld or a rivet connection. Alternatively, either one or both of the blade holder riser 22 and the cam riser 24 could be integrally formed with the base 12.

Positioned over the base 12 is a blade holder 26 with a fixed end 28 and a free end 30. The fixed end 28 is rotatably connected with the blade holder riser 22 with an axle 32 at a first pivot point. In a preferred embodiment, the axle 32 is a removable pin that allows the blade holder 26 to be removed for repairs or blade sharpening, however, the axle 32 can be any mechanism that allows the blade holder 26 to pivot.

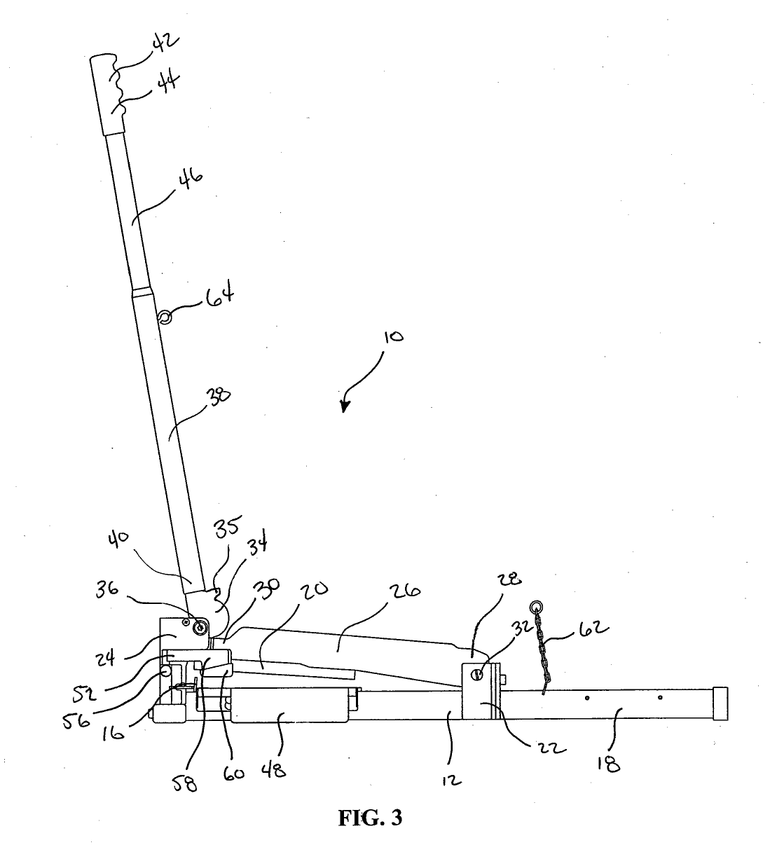

The blade 20 is preferably mounted to the blade holder 26 in a manner which allows the blade 20 to be detached, including, but not limited to, a threaded connection and a friction fit. Such a detachable mounting allows the blade to be removed for sharpening or repairs. However, the blade 20 can be permanently mounted to the blade holder with a weld, an adhesive connection, a friction fit or other type of connection. Alternatively, the blade 20 can be integrally formed with the blade holder 26. As shown in FIG. 3, the blade 20 includes a straight edge. In an alternative embodiment, the blade 20 includes a tapered portion that allows for improved cutting through some types of materials and allows the blade 20 to extend along a greater portion of the blade holder 26 and fit between the blade holder 26 and the base 12.

As shown in the figures, an eccentric cam 34 is positioned over and in contact with the free end 30 of the blade holder 26. The eccentric cam 34 is rotatably connected to the cam riser 24 with an axle 36 at a second pivot point. In an embodiment of this invention, the axle 36 is removable allowing for the eccentric cam to be removed for repairs and to provide access to the blade holder 26.

In an embodiment of this invention, the eccentric cam 34 includes a cam stop 35. In operation, the cam stop 35 contacts the blade holder 26 in the closed position, preventing the eccentric cam 34 from over-rotating and possibly damaging the cutting tool 10. The cam stop 35 can also provide additional leverage to force the blade 20 through tough-to-cut materials.

A handle 38 connects with the eccentric cam 34 and provides leverage to rotate the eccentric cam 34. In an embodiment of this invention, a proximate end 40 of the handle 38 fits over an extension of the eccentric cam 34 and is secured with a threaded connection. Alternatively, the handle 38 can be secured to the eccentric cam 34 with a weld or an adhesive connection. In an alternative embodiment, the handle 38 is integrally formed with the eccentric cam 34. A distal end 42 of the handle 38 preferably includes a hand grip 44 or other portion for the user to manually grab or engage. In an embodiment of this invention, the handle 38 further includes an extension 46 which provides additional leverage for rotating the eccentric cam 34.

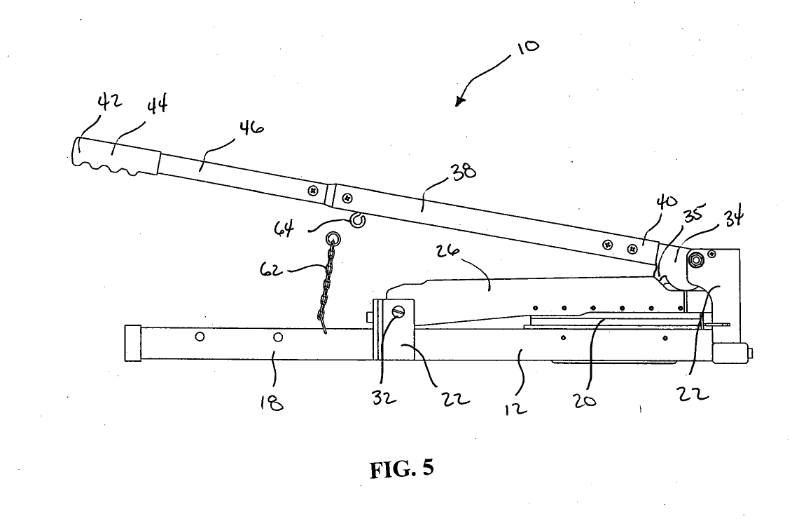

As shown in FIG. 5, the cutting tool 10 preferably includes a support arm 52 adjustably mounted to the base 12. The support arm 52 holds the material 50 against the support surface 14 to prevent the material 50 from moving during cutting ensuring a clean cut of the material 50. As shown in FIG. 2, the support arm 52 includes a mounting bracket 54, an adjusting screw 56, a support arm extension 58 and a foot 60.

The mounting bracket 54 and the screw 56 allow the support arm 52 to be secured at multiple positions to provide support of materials 50 of varying thickness. Alternatively, the mounting bracket 54 is biased in a downward direction by a spring, not shown, to hold the support arm 52 against the material 50.

The foot 60 is preferably manufactured from a rubber material but can be made of any material including, but not limited to, plastic, metals and composite materials. The material of the foot 60 is preferably capable of frictionally securing the position of the material 50 and is able to compensate for irregular surfaces of the material 50. In an alternative embodiment, the foot 60 can pivot or float to secure the material 50 and to compensate for irregular surfaces of the material 50.

The cutting tool 10 is preferably highly portable when the handle 38 is in the closed position. In a preferred embodiment, the cutting tool 10 includes a lock to maintain the cutting tool in the closed position. In FIG. 1, the lock is a latch 62 and a hook 64 which extend between the base 12 and the handle 38. In an alternative embodiment, the lock is a pin that fits into a receiver in the eccentric cam preventing the eccentric cam from rotating.

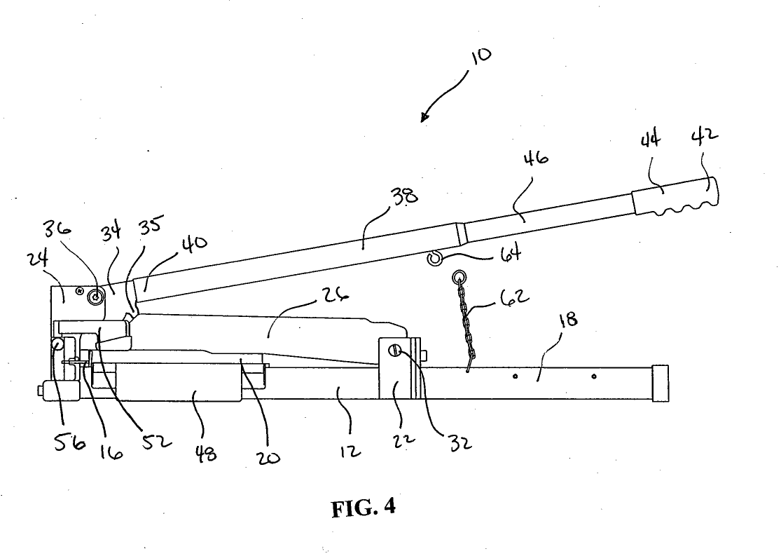

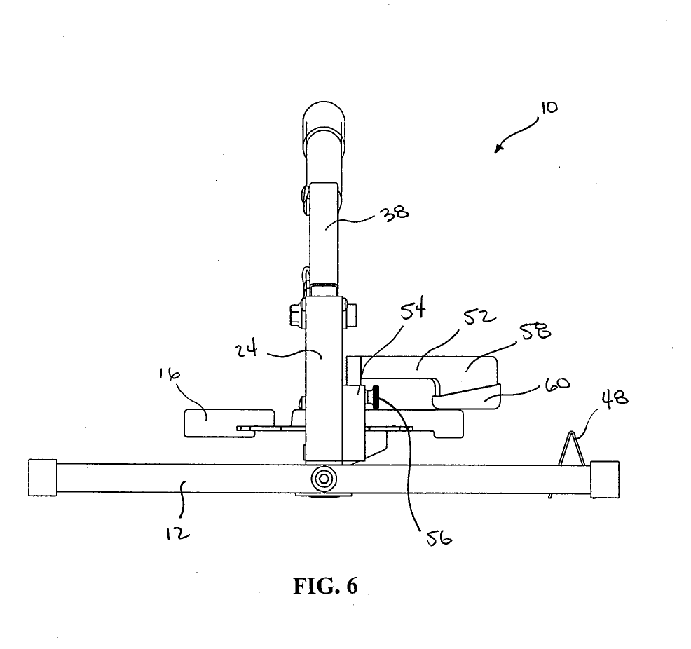

In operation, the cutting tool 10 of this invention starts in an open position, as shown in FIGS. 1-3. In the open position, a spring biases the blade holder 26 upward and the eccentric cam 34 contacts the blade holder 26 at a relatively small radius, this provides an opening between the blade 20 and a portion of the base 12, such as a blade stop 64. A user inserts the material 50 to be cut onto the base 12 and through the opening formed between the blade 20 and the base 12. To cut the material, the handle 38 is lowered to rotate the eccentric cam 34. By rotating the eccentric cam 34, a gradually increasing radius of the eccentric cam 34 contacts the blade holder 26 thereby forcing the blade 28 downward as the radius increases until the cutting tool 10 is in a closed position, as shown in FIGS. 4 and 6, thereby cutting the material 50. The resulting cut is optimally free of splinters and a resulting cut end of the material is otherwise clean and straight.

While in the foregoing specification this invention has been described in relation to certain preferred embodiments thereof, and many details have been set forth for purpose of illustration, it will be apparent to those skilled in the art that the material cutter is susceptible to additional embodiments and that certain of the details described herein can be varied considerably without departing from the basic principles of the invention.

What is claimed is:

1. A cutting tool comprising:
a base;
a blade holder pivotally connected to the base at a first pivot point;
an eccentric cam positioned over a portion of the blade holder and pivotally connected to the base at a second pivot point; and
a blade connected to the blade holder, wherein the blade holder and the blade are movable in a cutting direction from an open position to a closed position by actuating the eccentric cam.

2. The cutting tool of claim 1 further comprising:
a spring positioned between the blade holder and the base, wherein the spring biases the cutting tool towards the open position.

3. The cutting tool of claim 1, wherein the base includes a support surface for supporting a material to be cut.

4. The cutting tool of claim 1 further comprising:
a support arm adjustable with respect to the base, wherein the arm holds down the material against the support surface of the base.

5. The cutting tool of claim 1 further comprising:
a handle including a grip, wherein the handle provides leverage to rotate the eccentric cam about the second pivot point.

6. The cutting tool of claim 1, wherein the eccentric cam includes a cam stop, wherein in the closed position the cam stop contacts the blade holder to prevent the eccentric cam from over-rotating.

7. The cutting tool of claim 1, wherein the first pivot point comprises a pin to hinge the blade holder and the second pivot point comprises a second pin to hinge the eccentric cam.

8. The cutting tool of claim 1, wherein the blade includes a flat edge.

9. The cutting tool of claim 8, wherein the blade includes a tapered edge.

10. A cutting tool comprising:
a base including a support surface, a cam riser with a cam pivot point and a blade holder riser with a holder pivot point;
an eccentric cam connected to a handle, the eccentric cam hingely connected to the cam pivot point;
a blade holder in contact with the eccentric cam and hingely connected to the base at the holder pivot point;
a blade positioned on the blade holder, wherein the blade holder and the blade are movable in a cutting direction from an open position to a closed position by rotating the eccentric cam; and
a support arm adjustably connected to the base to hold a material to be cut against the support surface.

11. The cutting tool of claim 10 further comprising:
a spring positioned between the blade holder and the base, wherein the spring biases the cutting tool towards the open position.

12. The cutting tool of claim 10, further comprising:
a guide rail connected to the base to orientate the material at an angle with respect to the blade.

13. The cutting tool of claim 10, wherein the eccentric cam includes a cam stop, wherein in the closed position the cam stop contacts the blade holder to prevent the eccentric cam from over-rotating.

14. The cutting tool of claim 10, wherein the holder pivot point comprises an axle to hinge the blade holder and the cam pivot point comprises a second axle to hinge the eccentric cam.

15. A cutting tool comprising:
a base including a support surface;
a blade holder including a fixed end and a free end, the fixed end hingely connected to the base;
an eccentric cam positioned over the free end of the blade holder and rotatably connected to the base;
a handle extending from the eccentric cam;
a blade positioned on the blade holder, wherein the blade holder and the blade are movable in a cutting direction from an open position to a closed position by rotating the eccentric cam; and
a guide rail connected to the base, wherein the guide rail orientates a material to be cut at an angle to the blade.

16. The cutting tool of claim 15 further comprising:
a spring positioned between the blade holder and the base, wherein the spring biases the cutting tool towards the open position.

17. The cutting tool of claim 15 further comprising:
a support arm adjustable with respect to the base, wherein the support arm holds down a material to be cut against the support surface of the base.

18. The cutting tool of claim 15, wherein the eccentric cam includes a cam stop to prevent the eccentric cam from over-rotating in the closed position.

19. The cutting tool of claim 15, wherein the guide rail is adjustable to a plurality of angles with respect to the blade.

20. The cutting tool of claim 15, wherein the blade includes a flat edge.
